(19) United States
(12) Patent Application Publication
(10) Pub. No.: US 2013/0340907 A1
(43) Pub. Date: Dec. 26, 2013

(54) TIRE WITH A SEGMENTED OVERLAY LAYER

(71) Applicants: Matthieu Pingenat, Fameck (FR); Giorgio Agostini, Colmar-Berg (LU); Laurent Luigi Domenico Colantonio, Bastogne (BE); Filomeno Gennaro Corvasce, Porrentruy (CH); Tony Raymond Gery Deroo, Hettange Grande (FR); Anne Therese Peronnet-Paquin, Grand-Duchy (LU); Damien Albert Ghislain Schreurs, Schuttrange (LU)

(72) Inventors: Matthieu Pingenat, Fameck (FR); Giorgio Agostini, Colmar-Berg (LU); Laurent Luigi Domenico Colantonio, Bastogne (BE); Filomeno Gennaro Corvasce, Porrentruy (CH); Tony Raymond Gery Deroo, Hettange Grande (FR); Anne Therese Peronnet-Paquin, Grand-Duchy (LU); Damien Albert Ghislain Schreurs, Schuttrange (LU)

(21) Appl. No.: 13/528,905

(22) Filed: Jun. 21, 2012

(51) Int. Cl. B60C 9/00

(52) U.S. Cl. CPC B60C 9/00
USPC 152/209.18

(57) ABSTRACT

A pneumatic tire includes a pair of axially spaced apart annular bead cores, a carcass ply extending around both bead cores, a tread for engaging a contact surface and a belt structure. The tread has at least one circumferential groove extending radially inward from a radially outer surface of the tread. The belt structure includes at least one belt layer and an overlay comprising at least one overlay layer. The overlay layer is disposed under the circumferential groove and has an axial width between 70% and 200% of an axial width of the circumferential groove. The overlay layer is a reinforced ply layer or a layer comprising a fabric.

### FIELD OF THE INVENTION

The present invention relates to a pneumatic tire, and more particularly, to a pneumatic tire with tread groove reinforcement.

### BACKGROUND OF THE INVENTION

A pneumatic tire typically includes a pair of axially separated inextensible beads. A circumferentially disposed bead filler apex extends radially outward from each respective bead. At least one carcass ply extends between the two beads. The carcass ply has axially opposite end portions, each of which is turned up around a respective bead and secured thereto. Tread rubber and sidewall rubber are located axially and radially outward, respectively, of the carcass ply.

The bead area is one part of the tire that contributes a substantial amount to the rolling resistance of the tire, due to cyclical flexure which also leads to heat buildup. Under conditions of severe operation, as with runflat and high performance tires, the flexure and heating in the bead region can be especially problematic, leading to separation of mutually adjacent components that have disparate properties, such as the respective moduli of elasticity. In particular, the ply turnup ends may be prone to separation from adjacent structural elements of the tire.

The tire tread and tread cap area are other parts of the tire that contribute a substantial amount to the rolling resistance of the tire. Tread groove deformation may lead to subsequent heat buildup in the tread compound during operation of the tire, and vice versa, thereby increasing rolling resistance.

### SUMMARY OF THE INVENTION

A pneumatic tire in accordance with the present in invention includes a pair of axially spaced apart annular bead cores, a carcass ply extending around both bead cores, a tread for engaging a contact surface and a belt structure. The tread is disposed radially outward of the carcass ply. The tread has at least one circumferential groove extending radially inward from a radially outer surface of the tread. The belt structure is disposed radially between the carcass ply and the tread. The belt structure includes at least one belt layer and an overlay comprising at least one overlay layer. The overlay layer is disposed radially between the at least one belt layer and a radially innermost surface of the circumferential groove. The overlay layer is disposed under the circumferential groove and has an axial width between 70% and 200% of an axial width of the circumferential groove. The overlay layer is a reinforced ply or a fabric.

According to another aspect of the pneumatic tire, the overlay layer has an axial width corresponding to between 100% and 130% of the axial width of the circumferential groove.

According to still another aspect of the pneumatic tire, the overlay layer is a reinforced ply layer comprising parallel cords oriented in the range between −5 degrees to +5 degrees relative to an equatorial plane of the pneumatic tire.

According to yet another aspect of the pneumatic tire, the overlay layer comprises a dipped fabric.

According to still another aspect of the pneumatic tire, the overlay layer comprises a woven fabric or an unwoven fabric.

According to yet another aspect of the pneumatic tire, the overlay layer comprises a fabric selected from the group consisting of: a dipped calandered woven fabric, a dipped calandered unwoven fabric, a dipped non-calendered woven fabric, and a dipped non-calendered unwoven fabric.

According to still another aspect of the pneumatic tire, the overlay layer comprises a material consisting of one or more of: polyester, polyketone, polybenzobisoxazole (PBO), nylon, aramid, and rayon.

According to yet another aspect of the pneumatic tire, the overlay layer comprises a material consisting of two of: polyester, polyketone, polybenzobisoxazole (PBO), nylon, aramid, and rayon.

According to still another aspect of the pneumatic tire, the overlay layer comprises a metal, high tensile steel, super tensile steel, ultra tensile steel, or mega tensile steel.

According to yet another aspect of the pneumatic tire, the parallel cords comprise at least one of: a metal, polyester, aramid, rayon, and nylon.

According to still another aspect of the pneumatic tire, the overlay layer comprises a material consisting of two of: polyester, polyketone, polybenzobisoxazole (PBO), nylon, aramid, rayon, high tensile steel, super tensile steel, ultra tensile steel, and mega tensile steel.

According to yet another aspect of the pneumatic tire, the overlay layer comprises a material consisting of at least one of: polyester, polyketone, polybenzobisoxazole (PBO), nylon, aramid, and rayon; and a material consisting of at least one of: high tensile steel, super tensile steel, ultra tensile steel, and mega tensile steel.

According to still another aspect of the pneumatic tire, the carcass ply is wrapped around each bead core and has a pair of carcass ply turnups substantially contiguous with the carcass ply from the bead core to radially outer ends of the pair of carcass ply turnups.

According to yet another aspect of the pneumatic tire, the overlay layer comprises a plurality of axially segmented overlay layers, at least one of the plurality of axially segmented overlay layers being disposed under the circumferential groove, each of the plurality of axially segmented overlay layers having an axial width corresponding to between 70% and 200% or 100% and 130% of an axial width of the circumferential groove.

According to still another aspect of the pneumatic tire, the tread comprises a plurality of circumferential grooves extending radially inward from a radially outer surface of the tread, the overlay layer comprising a plurality of axially segmented overlay layers, each of the plurality of axially segmented overlay layers having an axial width corresponding to between 70% and 200% or 100% and 130% of a maximum of the axial widths of the circumferential grooves.

According to yet another aspect of the pneumatic tire, the tread comprises a plurality of circumferential grooves extending radially inward from a radially outer surface of the tread, the overlay layer comprising a plurality of axially segmented overlay layers, one of the axially segmented overlay layers being disposed under each of the circumferential grooves, each of the plurality of axially segmented overlay layers having an axial width corresponding to between 70% and 200% or 100% and 130% the axial width of the corresponding circumferential groove under which it is disposed.

According to still another aspect of the pneumatic tire, the number of axially segmented overlay layers corresponds to the number of circumferential grooves.

According to yet another aspect of the pneumatic tire, the number of axially segmented overlay layers is less than the number of circumferential grooves or the number of axially segmented overlay layers is higher than the number of circumferential grooves.

According to still another aspect of the pneumatic tire, the tread comprises a plurality of circumferential grooves extending radially inward from a radially outer surface of the tread, an axial arrangement of the at least one overlay layer being asymmetric with respect to an equatorial plane of the tire.

According to yet another aspect of the pneumatic tire, the tread comprises a plurality of circumferential grooves extending radially inward from a radially outer surface of the tread, an axial arrangement of the at least one overlay layer being symmetric with respect to an equatorial plane of the tire.

### Definitions

The following definitions are controlling for the present invention.

“Apex” means an elastomeric filler located radially above the bead core and between the plies and the turnup ply.

“Annular” means formed like a ring.

“Aspect ratio” means the ratio of its section height to its section width.

“Asymmetric tread” means a tread that has a tread pattern not symmetrical about the centerplane or equatorial plane EP of the tire.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa at 0.20 mm filament diameter.

“Vertical Deflection” means the amount that a tire deflects under load. “Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### BRIEF DESCRIPTION OF THE DRAWINGS

The structure, operation, and advantages of the invention will become more apparent upon contemplation of the following description taken in conjunction with the accompanying drawings, wherein:

FIG. 1 represents a schematic cross-sectional view of an example tire for use with the overlay layer of the present invention.

### DETAILED DESCRIPTION OF AN EXAMPLE EMBODIMENT

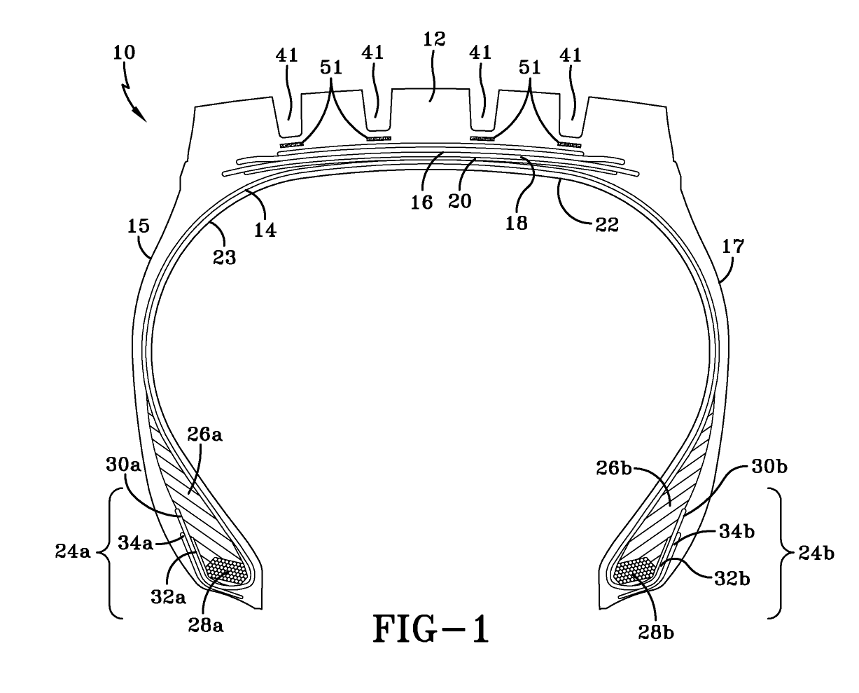

FIG. 1 shows an example tire 10 for use with an overlay layer in accordance with the present invention. The example tire 10 has a tread 12, an inner liner 23, a belt structure comprising three belts 16, 18, 20 and an overlay comprising a plurality (four in FIG. 1) of axially segmented overlay layers 51, a carcass 22 with a carcass ply 14, two sidewalls 15,17, and two bead regions 24a, 24b comprising bead filler apexes 26a, 26b and beads 28a, 28b. The example tire 10 is suitable, for example, for mounting on a rim of a passenger vehicle. The carcass ply 14 includes a pair of axially opposite end portions 30a, 30b, each of which is secured to a respective one of the beads 28a, 28b. Each axial end portion 30a or 30b of the carcass ply 14 is turned up and around the respective bead 28a, 28b to a position sufficient to anchor each axial end portion 30a, 30b.

The carcass ply 14 may be a rubberized ply having a plurality of substantially parallel carcass reinforcing members made of such material as polyester, rayon, or similar suitable organic polymeric compounds. The turned up portions of the carcass ply 14 may engage the axial outer surfaces of two flippers 32a, 32b and axial inner surfaces of two chippers 34a, 34b.

As shown in FIG. 1, the example tread 12 may have four circumferential grooves 41. The main portion of the tread 12 may be formed of a compound, which may be any suitable tread compound or compounds. Each circumferential groove 41 may be defined by a bottom or base laterally/axially separating a pair of radially extending walls (U-shaped).

The specific composition and physical properties of the compound of the tread 12 and additional overlay layers 51 in accordance with the present invention, and the relationships therebetween, will now be discussed. The additional overlay layers 51 may reduce the rolling resistance of the example tire 10. Also, the additional overlay layers 51 may be added over a full overlay layer (not shown).

It has been determined that the bottom area of circumferential tread grooves is a large contributor to overall rolling resistance of the tire 10. Moreover, this large contribution may be the result of high distortions in this area (e.g., high hysteresis). In accordance with the present invention, thin overlay layers 51 have been added to the area axially beneath the circumferential grooves 41 and radially outward of the belts 18, 20 (FIG. 1). Alternatively, the overlay layers 51 may be added under just one circumferential groove 41 or any combination of the grooves 41. These layers 51 may thus mitigate distortion in this area and decrease overall rolling resistance of the tire 10. The layers 51 may have an axial width equal to, slightly larger than, and/or slightly smaller than (e.g., between 70% and 200%, 70% and 130%, 80% and 120%, 90% and 110%, 95% and 105%, 100% and 130%, etc.) the axial width (e.g., between 5 mm and 20 mm) of the circumferential grooves 41.

The layers 51 may be plies of parallel or woven cords oriented generally in the circumferential direction of the tire 10 or in the range between −5 degrees to +5 degrees relative to the equatorial plane of the tire. The cords may be constructed of polyester, polyketone, polybenzobisoxazole (PBO), nylon, rayon, and/or other suitable organic and/or textile fibers.

As stated above, a plurality of overlay layers 51 in accordance with the present invention produces reduced rolling resistance in a pneumatic tire 10. These overlay layers 51 thus enhance the performance of the pneumatic tire 10, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the overlay, typically made up of many flexible, high modulus cords of natural textile, synthetic polymer, glass fiber, or fine hard drawn steel embedded in, and bonded to, a matrix of low modulus polymeric material, usually natural or synthetic rubber. Id. at 207 through 208.

The flexible, high modulus cords are usually disposed as a single layer. Id. at 208. Tire manufacturers throughout the industry cannot agree or predict the effect of different twists of overlay cords on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | LINER | CARCASSPLY | APEX | BELT | OV'LY | TREAD | MOLD |
|---|---|---|---|---|---|---|---|
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE COMFORT | X | X | X | | | X | |
| HIGH SPEED | | X | X | X | X | X | X |
| AIR RETENTION | X | | | | | | |
| MASS | X | X | X | X | X | X | X |

As seen in the table, overlay characteristics affect the other components of a pneumatic tire (i.e., overlay affects apex, belt, carcass ply, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (e.g., twist, cord construction, axial width, etc.) of the overlay of a pneumatic tire is modified with the intent to improve one functional property of the pneumatic tire, any number of other functional properties may be unacceptably degraded. Furthermore, the interaction between the overlay cords and the apex, belt, carcass, and tread may also unacceptably affect the functional properties of the pneumatic tire. A modification of the overlay cords may not even improve that one functional property because of these complex interrelationships.

Thus, as stated above, the complexity of the interrelationships of the multiple components makes the actual result of modification of an overlay, in accordance with the present invention, impossible to predict or foresee from the infinite possible results. Only through extensive experimentation have the overlay layers 51 of the present invention been revealed as an excellent, unexpected, and unpredictable option for a tire overlay.

The above description is given in reference to example embodiments of a tire having a tread portion for reducing rolling resistance and increasing fuel economy. However, it is understood that many variations are apparent to one of ordinary skill in the art from a reading of the disclosure of the invention. Such variations and modifications apparent to those skilled in the art are within the scope and spirit of the instant invention, as defined by the following appended claims.

Further, variations in the present invention are possible in light of the descriptions of it provided herein. While certain representative example embodiments and details have been shown for the purpose of illustrating the subject invention, it will be apparent to those skilled in this art that various changes and modifications can be made therein without departing from the scope of the subject invention. It is, therefore, to be understood that changes may be made in the particular example embodiments described which will be within the fully intended scope of the invention as defined by the following appended claims.

What is claimed:

1. A pneumatic tire comprising:
a pair of axially spaced apart annular bead cores;
a carcass ply extending around both bead cores;
a tread for engaging a contact surface, the tread being disposed radially outward of the carcass ply, the tread having at least one circumferential groove extending radially inward from a radially outer surface of the tread; and
a belt structure disposed radially between the carcass ply and the tread, the belt structure comprising at least one belt layer and an overlay comprising at least one overlay layer, the overlay layer being disposed radially between the at least one belt layer and the radially innermost surface of the circumferential groove,
the overlay layer being disposed under the circumferential groove and having an axial width between 70% and 200% of an axial width of the circumferential groove,
the overlay layer being a reinforced ply layer or a layer comprising a fabric.

2. The pneumatic tire as set forth in claim 1 wherein the overlay layer has an axial width corresponding to between 100% and 130% of the axial width of the circumferential groove.

3. The pneumatic tire as set forth in claim 1 wherein the overlay layer is a reinforced ply layer comprising parallel cords oriented in the range between −5 degrees to +5 degrees relative to an equatorial plane of the pneumatic tire.

4. The pneumatic tire as set forth in claim 1 wherein the overlay layer comprises a dipped fabric.

5. The pneumatic tire as set forth in claim 1 wherein the overlay layer comprises a woven fabric or an unwoven fabric.

6. The pneumatic tire as set forth in claim 4 wherein the overlay layer comprises a fabric selected from the group consisting of: a dipped calandered woven fabric, a dipped calandered unwoven fabric, a dipped non-calendered woven fabric, and a dipped non-calendered unwoven fabric.

7. The pneumatic tire as set forth in claim 1 wherein the overlay layer comprises a material consisting of one or more of: polyester, polyketone, polybenzobisoxazole (PBO), nylon, aramid, and rayon.

8. The pneumatic tire as set forth in claim 1 wherein the overlay layer comprises a material consisting of two of: polyester, polyketone, polybenzobisoxazole (PBO), nylon, aramid, and rayon.

9. The pneumatic tire as set forth in claim 1 wherein the overlay layer comprises a metal, high tensile steel, super tensile steel, ultra tensile steel, or mega tensile steel.

10. The pneumatic tire as set forth in claim 3 wherein the parallel cords comprise at least one of: a metal, polyester, aramid, rayon, and nylon.

11. The pneumatic tire as set forth in claim 1 wherein the overlay layer comprises a material consisting of two of: polyester, polyketone, polybenzobisoxazole (PBO), nylon, aramid, rayon, high tensile steel, super tensile steel, ultra tensile steel, and mega tensile steel.

12. The pneumatic tire as set forth in claim 1 wherein the overlay layer comprises a material consisting of at least one of: polyester, polyketone, polybenzobisoxazole (PBO), nylon, aramid, and rayon; and a material consisting of at least one of: high tensile steel, super tensile steel, ultra tensile steel, and mega tensile steel.

13. The pneumatic tire as set forth in claim 1 wherein the carcass ply is wrapped around each bead core and has a pair of carcass ply turnups substantially contiguous with the carcass ply from the bead core to radially outer ends of the pair of carcass ply turnups.

14. The pneumatic tire as set forth in claim 1 wherein the overlay layer comprises a plurality of axially segmented overlay layers, at least one of the plurality of axially segmented overlay layers being disposed under the circumferential groove, each of the plurality of axially segmented overlay layers having an axial width corresponding to between 70% and 200% of an axial width of the circumferential groove.

15. The pneumatic tire as set forth in claim 1 wherein the tread comprises a plurality of circumferential grooves extending radially inward from a radially outer surface of the tread, the overlay layer comprising a plurality of axially segmented overlay layers, each of the plurality of axially segmented overlay layers having an axial width corresponding to between 70% and 200% of a maximum of the axial widths of the circumferential grooves.

16. The pneumatic tire as set forth in claim 1 wherein the tread comprises a plurality of circumferential grooves extending radially inward from a radially outer surface of the tread, the overlay layer comprising a plurality of axially segmented overlay layers, one of the axially segmented overlay layers being disposed under each of the circumferential grooves, each of the plurality of axially segmented overlay layers having an axial width corresponding to between 70% and 200% of the axial width of the corresponding circumferential groove under which it is disposed.

17. The pneumatic tire of claim 16 wherein the number of axially segmented overlay layers corresponds to the number of circumferential grooves.

18. The pneumatic tire of claim 16 wherein the number of axially segmented overlay layers is less than the number of circumferential grooves or the number of axially segmented overlay layers is higher than the number of circumferential grooves.

19. The pneumatic tire as set forth in claim 1 wherein the tread comprises a plurality of circumferential grooves extending radially inward from a radially outer surface of the tread, an axial arrangement of the at least one overlay layer being asymmetric with respect to an equatorial plane of the tire.

20. The pneumatic tire as set forth in claim 1 wherein the tread comprises a plurality of circumferential grooves extending radially inward from a radially outer surface of the tread, an axial arrangement of the at least one overlay layer being symmetric with respect to an equatorial plane of the tire.
